(19) United States
(12) Patent Application Publication
(10) Pub. No.: US 2013/0219316 A1
(43) Pub. Date: Aug. 22, 2013

(54) SYSTEM AND METHOD FOR VISUALISING A SCENARIO

(71) Applicant: Bruce Taper, North Bondi (AU)

(72) Inventor: Bruce Taper, North Bondi (AU)

(73) Assignee: KINESIS PTY LTD, Surry Hills (AU)

(21) Appl. No.: 13/695,131

(22) PCT Filed: May 2, 2011
(86) PCT No.: PCT/AU11/00497

§ 371 Date: Dec. 23, 2012

(30) Foreign Application Priority Data
Apr. 30, 2010 (AU) 2010901862

(51) Int. Cl. G06F 3/0484

(52) U.S. Cl. CPC G06F 3/0484
USPC 715/771

(57) ABSTRACT

The present invention relates to a method and system for visualising and modelling metrics in a complex system, such as an urban area (e.g. a city). In particular, the method and system finds use in monitoring, modelling and reporting on a large number of interconnected metrics, such as greenhouse gas emissions. The method and system provide an important visual tool for visualising and modelling complex systems.

### FIELD OF THE INVENTION

The present invention relates to a method and system for visualising and modelling metrics in a complex system, such as an urban area (e.g. a city). In particular, the method and system finds use in monitoring, modelling and reporting on a large number of interconnected metrics, such as greenhouse gas emissions. The method and system provide an important visual tool for visualising and modelling complex systems.

### DESCRIPTION OF BACKGROUND ART

In recent years, the issue of sustainability has become increasingly important on a global level. Sustainability metrics include greenhouse gas emissions, water consumption, waste generation, embodied greenhouse gas emissions and embodied water. Of these, by far the most discussed sustainability metric has been greenhouse gas emissions (GHGe).

In order to be used for inter-agency carbon reporting and trading, quantification of such emissions as tonnes equivalent of CO₂ must be carried out in accordance with internationally recognised protocols, such as the International Standards Organisation (ISO) 14064:2006. These protocols prescribe regular reporting and place emphasis on the performance of greenhouse mitigating actions. The actions are often defined in terms of effected change with respect to a user-specified base year or any other benchmark data.

However, software applications and systems designed to provide reporting and tracking of Greenhouse Gas production and mitigation actions are either simplistic applications which require a high degree of user input and knowledge, or are specialist applications which are not user friendly and require a large amount of semi-private data which is generally not available to private users and organisations.

### SUMMARY OF THE INVENTION

In accordance with a first aspect, the present invention provides a method of visualising a sustainability metric of one or more inventory groups, each group comprising one of more operational units, the method comprising the steps of:

receiving at least one of consumption data and one or more inventory parameters associated with each of the one or more inventory groups;

determining a factual sustainability metric of the one or more inventory groups, based on the received at least one of consumption data and one or more inventory parameters;

determining a model sustainability metric of the one or more inventory groups in at least one model scenario, the model scenario comprising modifying at least one of received consumption data and a received inventory parameter, to assess the effect of the modification of the factual sustainability metric; and

displaying at least one of the sustainability metric groups and the inventory or the consumption data in a Graphical User Interface.

In an embodiment of the present invention, there is provided a Graphical User Interface having at least two sub-regions, the first sub-region providing a visual representation of the one or more inventory groups, and the second sub-region containing one or more of the consumption data and the sustainability metric.

In one embodiment of the present invention, the inventory groups are collocated within a geographical area.

In one embodiment of the present invention, the geographical area is displayed as a map.

In one embodiment of the present invention, the map is interactive, to allow a user to view sub-regions of the map in more detail.

In one embodiment of the present invention, the information in the second sub-region is varied to reflect is the sub-region selected by the user.

In one embodiment of the present invention, the display provides a series of graphs, the graphs providing an aggregate of at least one of the consumption data, the one or more inventory parameters associated with the one or more inventory groups and the at least one model scenario.

In accordance with a second aspect, the present invention provides a system for visualising a sustainability metric of one or more inventory groups, each group comprising one of more operational units, the method comprising the steps of:

a receiving module to receive at least one of consumption data and one or more inventory parameters associated with each of the one or more inventory groups;

a determining module arranged to determine a factual sustainability metric of the one or more inventory groups, based on the received at least one of consumption data and one or more inventory parameters;

the determining module also being arranged to determine a model sustainability metric of the one or more inventory groups in at least one model scenario, the model scenario comprising modifying at least one of received consumption data and a received inventory parameter, to assess the effect of the modification of the factual sustainability metric; and

and a display module arranged to provide instructions to display at least one of the sustainability metric groups and the inventory or the consumption data in a Geographical User Interface.

In accordance with a third aspect, the present invention provides a computing program, arranged to, when executed on a computing system, perform the method steps in accordance with the first aspect of the invention.

In accordance with a fourth aspect, the present invention provides a computer readable medium incorporating a computer program in accordance with the third aspect of the invention.

### BRIEF DESCRIPTION OF THE DRAWINGS

Notwithstanding any other embodiments that may fall within the scope of the present invention, an embodiment of the present invention will now be described, by way of example only, with reference to the accompanying figures, in which:

FIG. 1 is a schematic block diagram of a general purpose computer system upon which an embodiment of the present invention may be operated; and

FIGS. 2 to 11 are screen shots of a Graphical User Interface in accordance with a computer program implementing an embodiment of the invention.

### DETAILED DESCRIPTION

### Overview

The foregoing describes only a preferred embodiment of the present invention and modifications, obvious to those skilled in the art, can be made thereto without departing from the scope of the present invention.

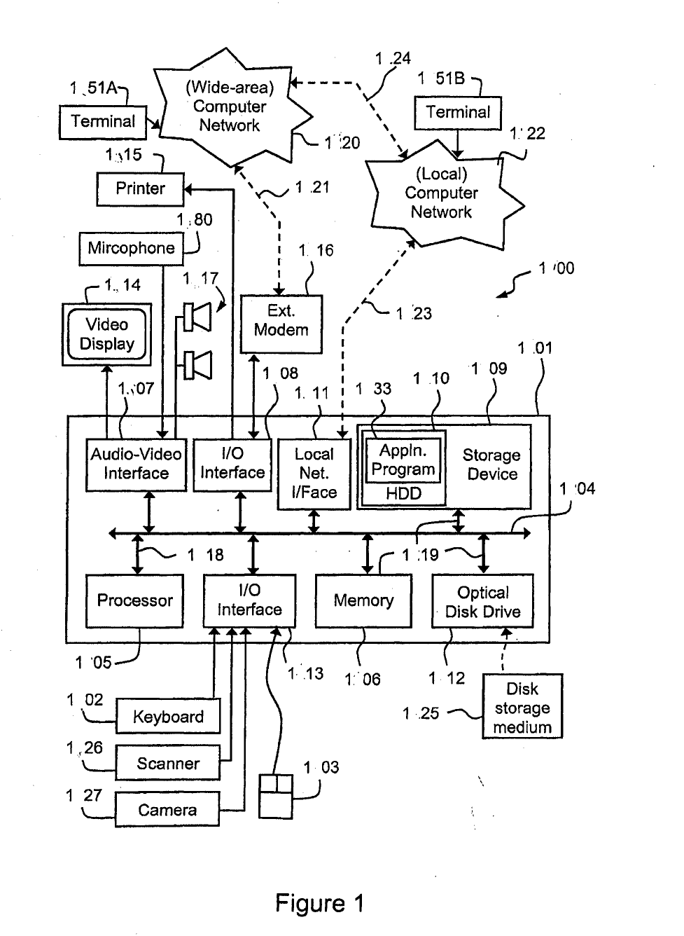

FIG. 1 is a schematic block diagram of a general purpose computer system 100, upon which the method may be practised.

As seen in FIG. 1, the computer system 100 is formed by a computer module 101, input devices such as a keyboard 102 (which may include a virtual keyboard arranged to be provided via a display device 114), a mouse pointer device 103, a scanner 126, a camera 127, and a microphone 180, and output devices including a printer 115, the display device 114 and loudspeakers 117. An external Modulator-Demodulator (Modem) transceiver device 116 may be used by the computer module 101 for communicating to and from a communications network 120 via a connection 121. The network 120 may be a wide-area network (WAN), such as the Internet or a private WAN. Where the connection 121 is a telephone line, the modem 116 may be a traditional “dial-up” modem. Alternatively, where the connection 121 is a high capacity (e.g. cable) connection, the modem 116 may be a broadband modem. A wireless modem may also be used for wireless connection to the network 120.

The computer module 101 typically includes at least one processor unit 105, and a memory unit 106 for example formed from semiconductor random access memory (RAM) and semiconductor read only memory (ROM). The module 101 also includes a number of input/output (I/O) interfaces including an audio-video interface 107 that couples to the video display 114, loudspeakers 117 and microphone 180, an I/O interface 113 for the keyboard 102, mouse 103, scanner 126, camera 127 and optionally a joystick (not illustrated), and an interface 108 for the external modem 116 and printer 115. In some implementations, the modem 116 may be incorporated within the computer module 101, for example within the interface 108. The computer module 101 also has a local network interface 111 which, via a connection 123, permits coupling of the computer system 100 to a local computer network 122, known as a Local Area Network (LAN). As also illustrated, the local network 122 may also couple to the wide network 120 via a connection 124, which would typically include a so-called “firewall” device or device of similar functionality. The interface 111 may be formed by an Ethernet™ circuit card, a Bluetooth™ wireless arrangement or an IEEE 802.11 wireless arrangement. A terminal 151 A is located on the WAN 120 and is, thus, connected to the computer module 101 via a connection 121. Similarly, a terminal 151B is located on the LAN 122 and is connected with module 101 by way of a link 123.

The interfaces 108 and 113 may afford either or both of serial and parallel connectivity, the former typically being implemented according to the Universal Serial Bus (USB) standards and having corresponding USB connectors (not illustrated). Storage devices 109 are provided and typically include a hard disk drive (HDD) 110. Other storage devices such as a floppy disk drive and a magnetic tape drive (not illustrated) may also be used. An optical disk drive 111 is typically provided to act as a non-volatile source of data. Portable memory devices, such optical disks (e.g. CD-ROM, DVD), USB-RAM, and floppy disks for example may then be used as appropriate sources of data to the system 100. The components 105 to 113 of the computer module 101 typically communicate via an interconnected bus 104 and in a manner which results in a conventional mode of operation of the computer system 100 known to those in the relevant art. Examples of computers on which the described arrangements can be practised include IBM-PC's and compatibles, Sun Sparcstations, Apple Mac™ or alike computer systems evolved therefrom.

The method for determining a sustainability metric may be implemented using the computer system 100 wherein the processes, to be described, may be implemented as one or more software application programs 133 executable within the computer system 100. In particular, the steps of the method are effected by instructions 131 in the software 133 that are carried out within the computer system 100. The software instructions 131 may be formed as one or more code modules, each for performing one or more particular tasks. The software may also be divided into two separate parts, in which a first part and the corresponding code modules performs various steps of the method and a second part and the corresponding code modules manage a user interface between the first part and the user.

The software 133 is generally loaded into the computer system 100 from a computer readable medium, and is then typically stored in the HDD 110, as illustrated in FIG. 1, or the memory 106, after which the software 133 can be executed by the computer system 100. In some instances, the application programs 133 may be supplied encoded on one or more CD-ROM 125 and read via the corresponding drive 11 prior to storage in the memory 110 or 106. Alternatively the software 133 may be read by the computer system 100 from the networks 120 or 122 or loaded into the computer system 100 from other computer readable media. Computer readable storage media refers to any storage medium that participates in providing instructions and/or data to the computer system 100 for execution and/or processing. Examples of such storage media include floppy disks, magnetic tape, CD-ROM, a hard disk drive, a ROM or integrated circuit, USB memory, a magneto-optical disk, or a computer readable card such as a PCMCIA card and the like, whether or not such devices are internal or external of the computer module 101. Examples of computer readable transmission media that may also participate in the provision of software, application programs, instructions and/or data to the computer module 101 include radio or infra-red transmission channels as well as a network connection to another computer or networked device, and the Internet or Intranets including e-mail transmissions and information recorded on Websites and the like.

The modelling capabilities of the software application (i.e. the aforementioned “first part of the software application”) are described in an, earlier filed application by the same Applicant, namely PCT/AU2009/000408, entitled “A METHOD AND SYSTEM FOR DETERMINING A SUSTAINABILITY METRIC”, which is incorporated herein by reference. The software application described in the earlier PCT Application provides a carbon accounting application which allows for the setting of targets and the development of mitigation and reduction verification strategies. In particular, the described method in the earlier PCT Application allows for modelling of a possible portfolio of assets scenarios, described by different inventory parameters, and the calculating of GHGe resulting from the operation of a given portfolio of assets. Such a portfolio is usually subdivided into subgroups of assets consuming the same or similar types of energy resources. The assets may include buildings, building sites, shopping centres, factories, etc. A group or subgroup of assets will be referred to as an “inventory group”.

The inventory parameters may include number, type and technical data of various assets included in an inventory group associated with a business sustainability account. The inventory parameters may also include resource bases (e.g. fuel, energy, refrigeration gas use etc.), number and type of operational units within an inventory group, as well as any efficiency coefficients of the operational units.

In the context of the embodiment described herein, the activities associated with greenhouse gas emission are related to the emissions produced by various entities (i.e. individuals, businesses, other organisations, etc) within a defined geographical area, such as a “Council” area or a “County” area). It will be understood that while the previous PCT Application was concerned primarily with the accounting of greenhouse gas emissions for an organisation, such as a corporation, the present embodiment is primarily directed to Government and Quasi-Government organisations, such as Local or Regional Government Authorities that have partial or complete control over land use activities carried out within a defined geographical area. However, it will be understood that while the example provide herein is described with respect to Local or Regional Government Authorities, the broader invention has application to any geographical area, such as a city, a state/region or indeed, to an entire country or legal jurisdiction.

The method allows a greenhouse emissions account to be assembled for a given portfolio of physical assets according to internationally recognised protocols. Account data allows an overview to be extracted of the consumption of a broad range of resources. The method also allows the quantification of various strategies for mitigating resultant greenhouse emissions, through changes to inventory parameters. The inventory parameters are directly or indirectly related to the business activities, the number and/or the type of assets associated with a particular portfolio.

To reiterate, in the example provided in the present specification, there is described a particular application which is dubbed “CCAP City”. CCAP City focuses on inventory groups around Local Government Authorities such as Councils (i.e. municipalities or counties), which are geographically bounded (i.e. all assets and inventory groups generally reside within a defined geographical area).

### Graphical User Interface

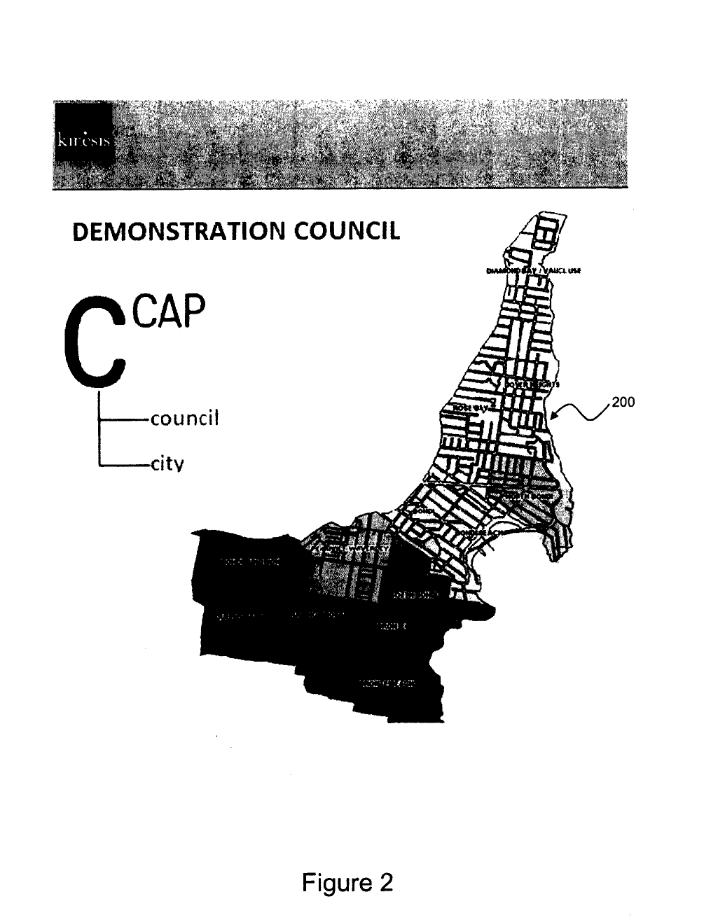

The second part of the application programs 133 and the corresponding code modules mentioned above may be executed to implement one or more Graphical User Interfaces (GUIs) to be rendered or otherwise represented upon the display 114. Example screen shots of a GUI in accordance with an embodiment of the invention are shown in FIGS. 2 to 11. Through manipulation of typically the keyboard 102 and the mouse 103, a user of the computer system 100 and the computer application program 133 may manipulate the interface in a functionally adaptable manner to provide controlling commands and/or input to the applications associated with the GUI(s).

However, while the application from the earlier PCT application describes the methodology for calculating various sustainability metrics based on dividing assets into inventory groups, the embodiment described herein provides an overlay, in the form of a Graphical User Interface, which allows a user to interact with the application in a sophisticated and seamless manner.

In particular, turning to FIGS. 2 to 12, there are shown a number of screenshots of the Graphical User Interface, each screen shot providing specific information and navigation tools which allow the user to both view complex data in a simple and intuitive manner, and also to manipulate data and model scenarios in a simple and intuitive manner.

Turning to FIG. 2, there is shown a geographical map, which in the example, is a “Council” (i.e. municipal or county) region 200, which is defined by a particular geographical/physical border. The map provides basic information on sub-regions (e.g. wards) in the council area, and allows a user to “click” on a region to access further information about the region. In this manner, the user can visually navigate the entire geographical area to zoom in or focus on regions of interest in an intuitive manner.

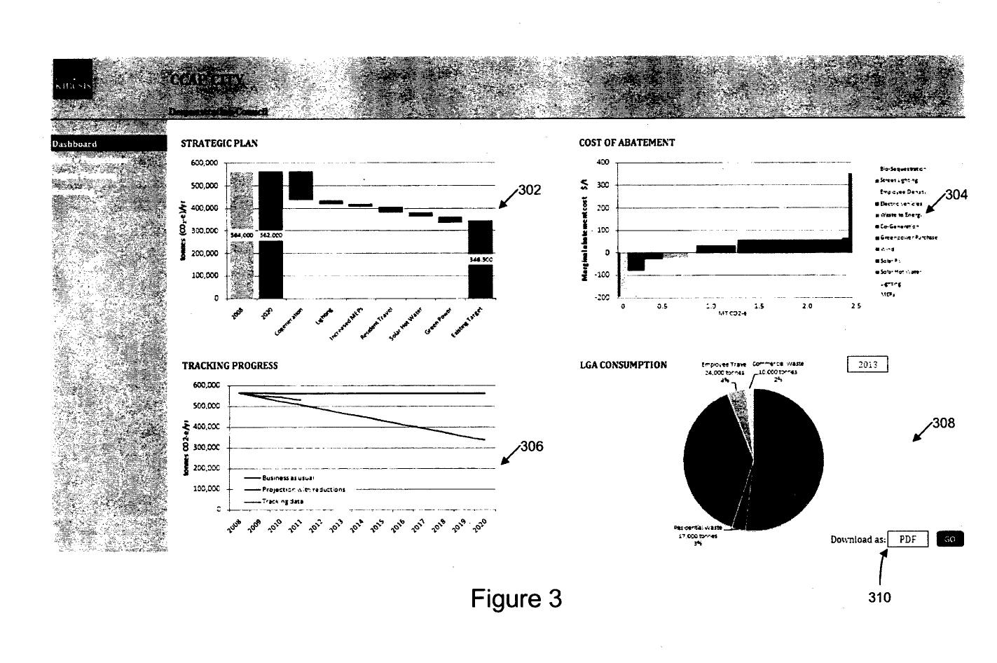

Turning to FIG. 3, there is shown a further example screen of the GUI. In this screen shot, there is provided a summary or overview page (also referred to as the “dashboard” page). The Dashboard provides a number of “at a glance” graphs which provide the user with a rich amount of data (both actual data and modelled data) on some strategic indicators regarding the aggregate council area. In particular, there is included a strategic plan graph 302, which outlines current aggregate Greenhouse Gas output and the proposed future aggregate Greenhouse Gas output, in the form of a waterfall graph which outlines the strategies by which Greenhouse Gas output will be reduced. There is also provided a Cost of Abatement Graph, which provides a graphical representation of the cost and magnitude of greenhouse gas emission reductions for each discrete action, such as bio sequestration, street lighting, employee density, electric vehicles, waste to energy, co-generation, ring power purchase, wind, solar photovoltaic cell installation, solar hot water installation, changes to lighting on private properties and various other carbon reduction strategies.

There is also provided a tracking progress graph 306, which provides three projections, namely the amount of greenhouse gas that would be emitted if no action is taken, the projected reduction in greenhouse gas if all proposed strategies are followed as required, and the actual live data on the amount of greenhouse gas reduction to date. There is further provided a consumption graph which breaks down the entire population of the geographical area into particular sectors, such as commercial buildings, residential dwellings, commercial waste, etc and describes the percentage of greenhouse gas emissions that can be attributed to each activity.

In other words, the dashboard provides a quick at a glance view of both the current state of play within a geographical area and also the projected strategy and progress to date. As such, such graphs can be easily printed or downloaded into an electronic document by using button 310. This allows a user of the application to easily distribute the content or incorporate the content into a report or other document.

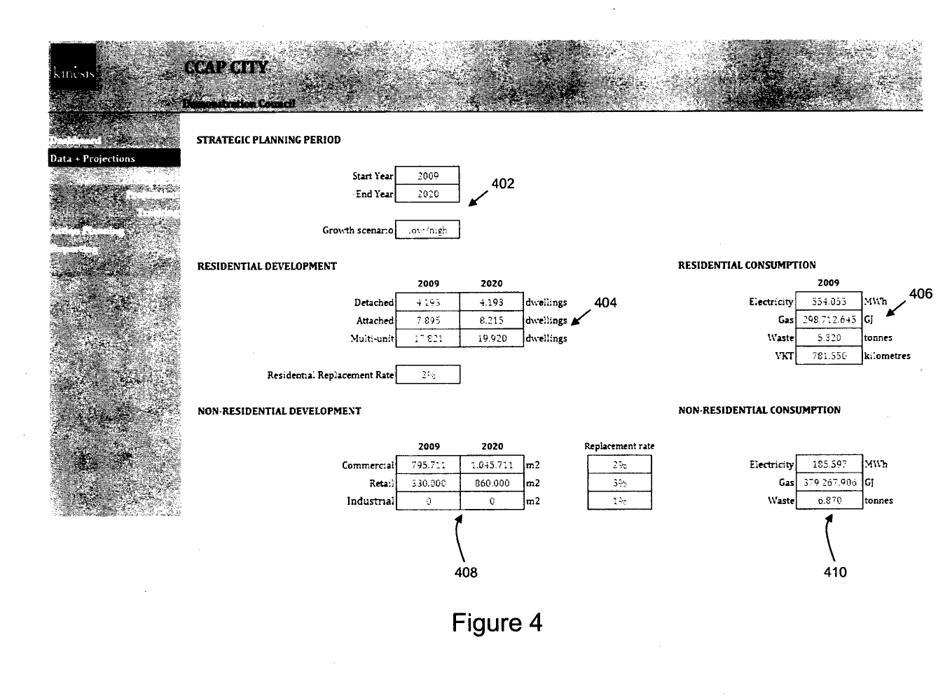

Turning to FIG. 4, there is shown a capture of a screen which provides more detail on the actual composition of residential and non-residential developments within the geographical area. In particular at 402 there is shown the proposed planning data over a particular time period. Further, at 404 there is shown the current number of dwellings (and their type) both at the present time and the proposed number of dwellings at a predetermined future date. There is also provided at 406 a snap shot of the resources currently utilised by the total number of residential developments. At 408 and 410 there are provided corresponding metrics for non-residential developments. As such, a snap shot can be provided of the proposed changes to the make-up of the properties in the residential area.

The screen displayed at FIG. 4 also provides an input function, such that a user can change the rate of growth of the residential and non-residential dwellings within the geographical area. While much of the data required to model or predict growth is pre-populated in a database, a user with appropriate access is able to vary the rate of growth by changing the numerals displayed generally at 404. Not only can the rate of growth be changed, but also the replacement rate can be changed (i.e. the rate at which one type of dwelling is replaced by another type of dwelling—to avoid double counting of dwellings). As such, the screen of FIG. 4 provides the user with the ability to model, in real time, substantive changes to land use within the geographical area and such changes will be automatically translated into variations in greenhouse gas emissions.

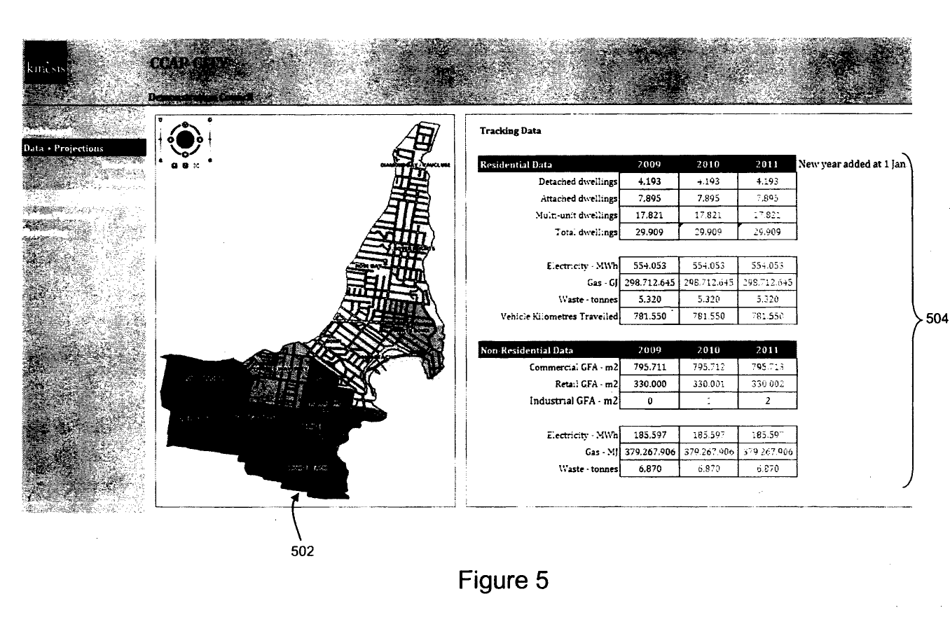

Turning to FIG. 5, there is shown a screen shot of the Graphical User Interface including a two-dimensional map of the geographical area. At 502 the map 502 is interactive, such that a user may click on area of the map to “zoom in” and thereby receive detail with regard to a specific sub-area or sub-region within the geographical area. This feature will be explained in more detail with reference to subsequent Figures. Returning to FIG. 5, at 504 there is provided a snap shot of residential and non-residential data (similar to the data provided in FIG. 4). However, in FIG. 5, the data is provided utilising a year-by-year breakdown so that particular trends and changes may easily be identified by the user.

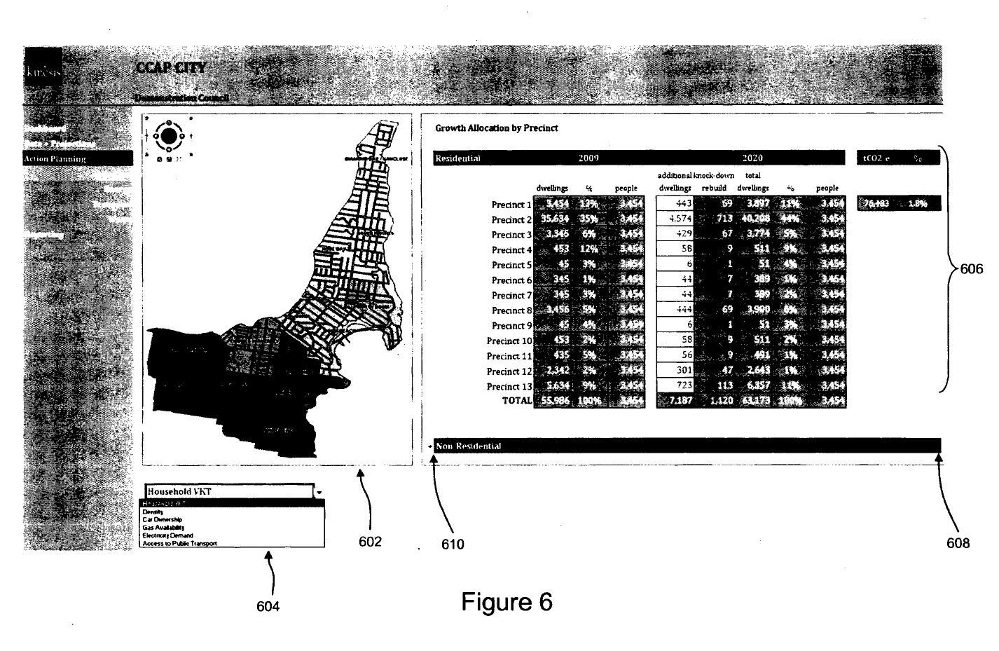

At FIG. 6, there is shown a further screen shot of the Graphical User Interface, which includes a two-dimensional map 602. Further there is provided a drop down menu 604. The drop down menu 604 provides a list of various metrics, such as housing/property density, car ownership, gas availability, electricity demand and access to public transport. By selecting an item in the drop down menu 604, an overlay (not shown) is provided on map 602 which provides a visual representation of the particular metric. To provide an example, if a user chooses the option “gas availability”, various lines are superimposed on the map to show where gas is available within the geographical area. As such, the user of the system can use this information to make planning decisions (e.g. a decision to increase or decrease the number of dwellings within a particular precinct). Such decisions are facilitated by the information provided generally at region 606 of the Graphical User Interface. At region 606 there is provided a breakdown of the total number of dwellings within each precinct in the geographical area, plus a projected number of dwellings (and the corresponding number of people living in each precinct), which aids the user in determining whether particular precincts are suitable for further development. A corresponding breakdown of non-residential properties is also provided at 608 (but not shown in this particular example). There is further provided a selectable button which allows the user to either collapse or expand a section. In the present example at FIG. 6, the non-residential information is shown in the collapsed format (i.e. it is not visible on the screen). By clicking on the selectable button 610, the user can expand this section of the screen to display the information.

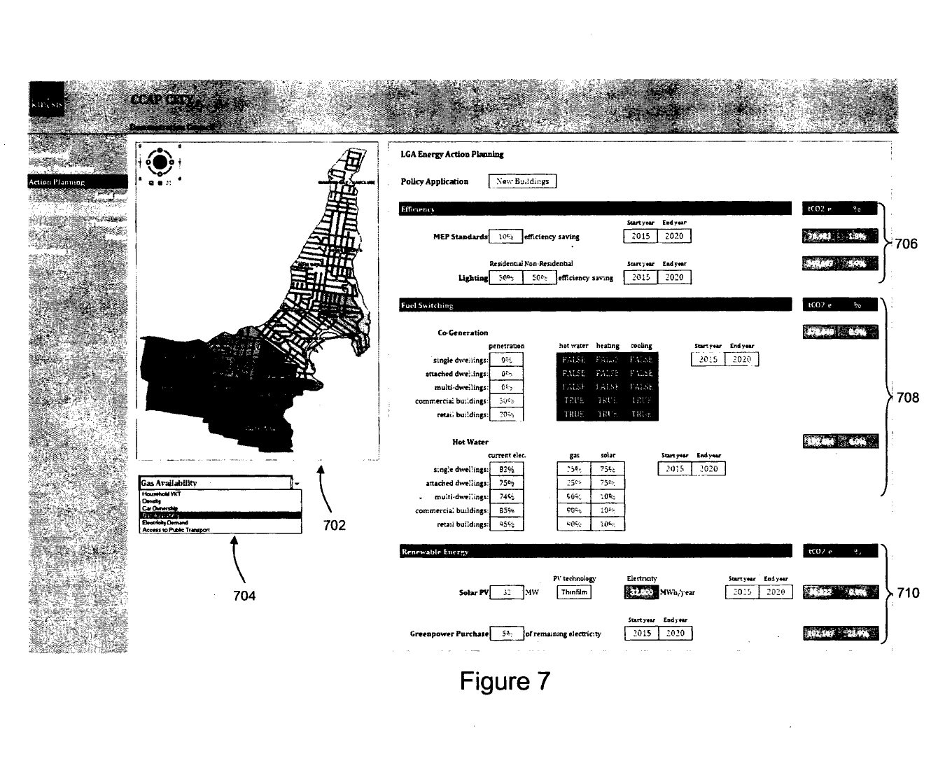

At FIG. 7, there is shown an energy action planning screen including the two-dimensional map 702 and the drop down menu 704 (which act in a similar fashion to the map and drop down menu described in FIG. 6). The energy action planning screen outlines energy use across the entire area defined by the map broken down to provide a number of efficiency metrics 706, a number of potential projections if fuel or resources are modified or switched (generally at section 708) and a snap shot of the amount of renewal energy utilised within the geographical area (as denoted generally at area 710). It is instructive to note that there are a number of variables on this screen which may be changed by a user. The variables shown in a greyed box may be varied by the user to model various scenarios. By allowing the user to change certain variables, the user has the ability to see how such changes flow through over a defined period of time and in turn change various other variables such as the amount of greenhouse gas emitted. As such, the screen of FIG. 7 allows the user to model the effect of various building policies (e.g. such as requiring all new buildings to install gas or solar hot water systems).

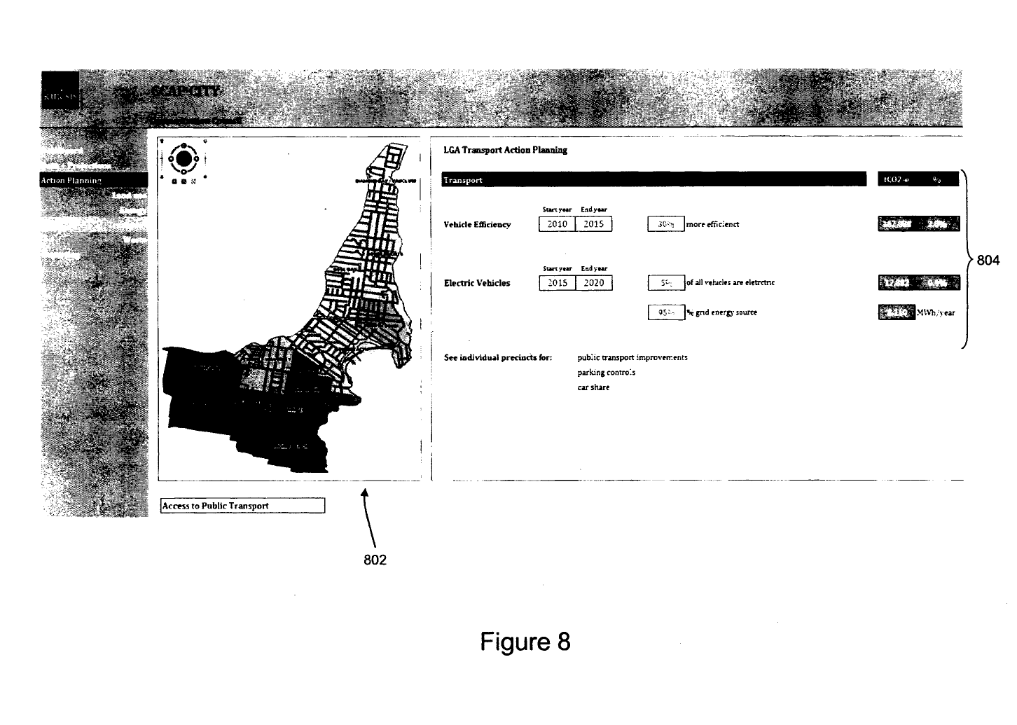

Turning to FIG. 8, there is shown a transport action planning screen with map 802. At general area 804 there is shown a snap shot of the aggregate vehicle efficiency within municipal area and total carbon output for the vehicles in questions.

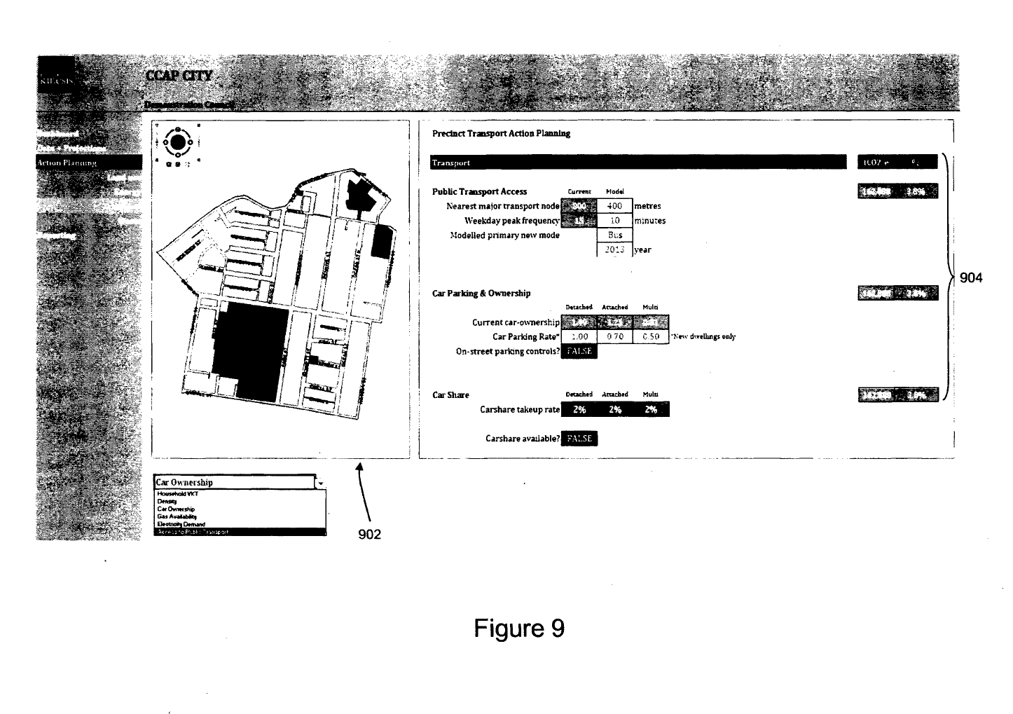

Turning to FIG. 9, there is shown an example of a particular sub-area or sub-region within the municipality. That is, map 902 provides an example of the map shown when a user chooses to zoom into a particular sub-area or sub-region. Comparing the map 902 of FIG. 9 to the map 802 of FIG. 8, it will be seen that map 902 provides a view of a sub-area of map 802. Furthermore, when a user zooms into a particular sub-area, more specific information about the particular sub-area is shown. Again, it is instructive to compare the summary information provided at 804 and the summary information provided at 904. At 804, an aggregate of vehicle efficiency and the number of electric vehicles for the entire geographical area is given. At 904, more detailed information is provided about transport, including the ease of access to public transport, the car ownership and car park rates, and any car share programs that may be in place. As such, by simply clicking on the map, the user can hone in on particular sub-areas and review specific metrics (i.e. review more detailed information). This provides a particularly powerful planning tool, as the user is able to not only make decisions based on aggregate data for the entire geographical area, but is able to micromanage particular sub-areas, depending on specific needs.

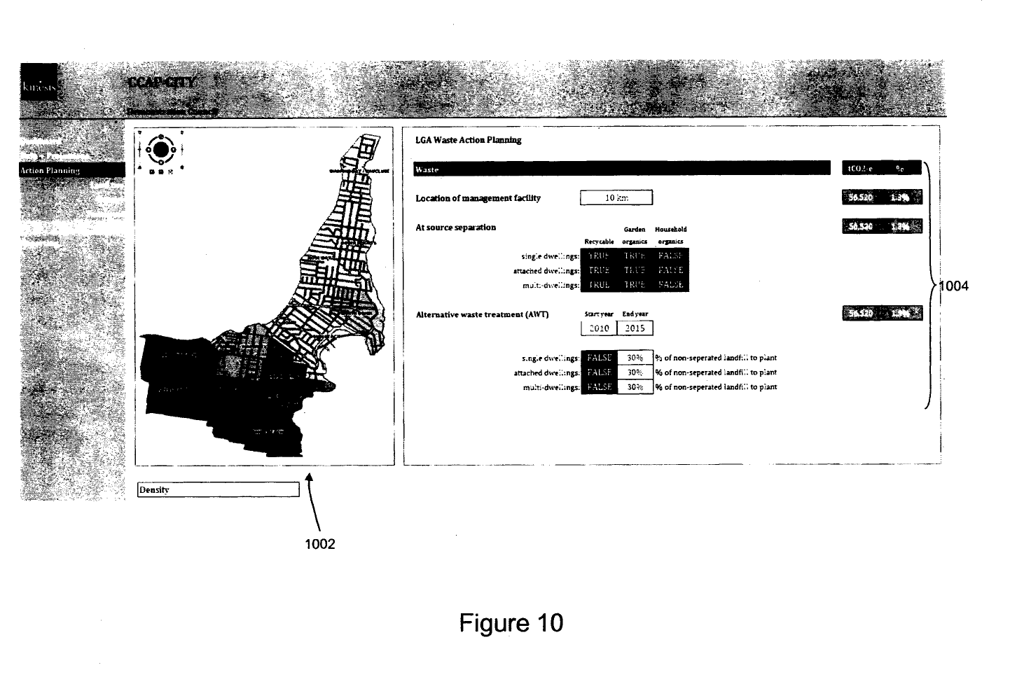

Turning to FIG. 10, there is shown the map 1002 and detailed information regarding the waste action plan for the area shown generally at 1004. Again, there are various quantities or switches (i.e. “true” or “false” switches), which allow a user to easily change certain policies and thereby automatically model the flow through affects of changes in such policies.

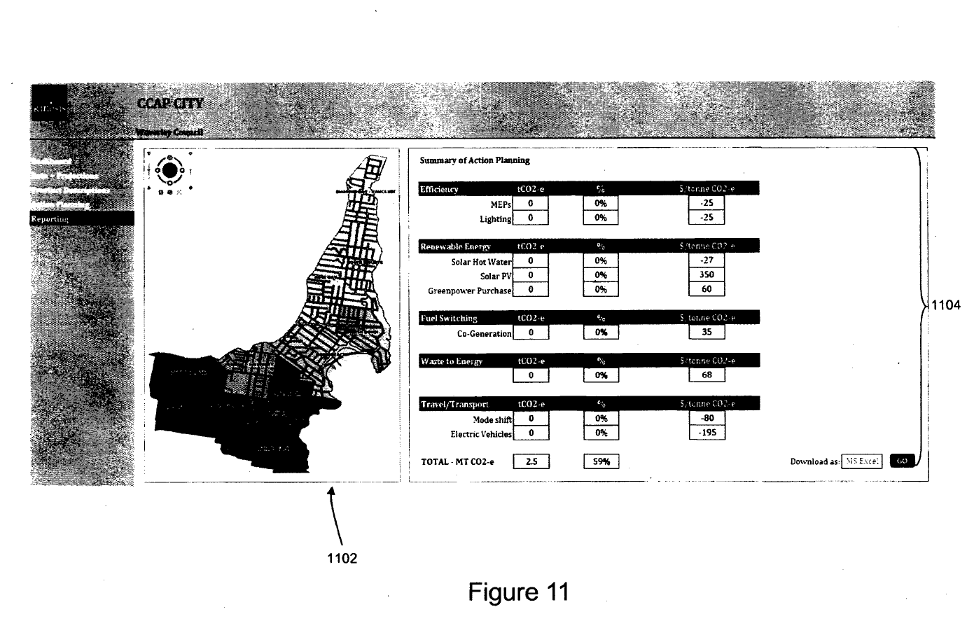

Lastly, at FIG. 11, there is shown a screen which provides similar information to the screen shown at FIG. 3. However, as the map 1102 is provided and a summary of the key metrics is provided in a numerical form generally at 1104 (rather than in a graphical form), the user can use the map 1102 to zoom into particular areas and receive information on specific sub-areas, rather than the aggregate data which is provided by the graph shown at FIG. 3.

As such, taking FIGS. 2 to 11 in their entirety, it can be seen that the Graphical User Interface provides a visualisation tool with a number of important features. Firstly, the visualisation tool provides a way to visualise aggregate data and strategies (e.g. FIG. 3). However, through use of a map and through the ability of a user to click on the map and thereby zoom into specific areas, the Graphical User Interface also provides a powerful planning and modelling tool, as the user can both focus on specific sub-areas within the geographical area and can also focus on specific metrics or policies. Each time the user changes a particular value on any of the screens (i.e. FIGS. 4 to 11), all interlinked values and all interdependent values are automatically recalculated. As such, the user can quickly and easily preview the consequences of changing a particular policy or changing a particular “mix” of policies. Moreover, the user can see the consequences of such changes both at a macro level and at a micro level. This is due to the fact that the Graphical User Interface is integrated seamlessly with the modelling component of the software application, such that a user does not require any programming or database knowledge to either view data in a sophisticated manner or to model various scenarios.

### Data Storage

As will be described below, the method is implemented by the one or more application programs (e.g. 133) that are hosted on a dedicated application server. As the computer module 101 represents a typical implementation of such a server, the computer module 101 will also be referred to below as an “application server 101”. In one implementation, the application server 101 will be maintained by a company that provides service administration of the method and the application program 133. This company may be referred to as the service administrator. Apart from the service administrator, there are users, which represent other companies that wish to use the services including the method as facilitated by the service administrator. Any account data associated with the structure of a business organisation (referred to below as a portfolio of assets) may also be stored on the application server 101. Alternatively, the account data may be stored on a user company's server with a secure connection to the application server 101. Implementations where the user company provides its own service administration and all the data is stored on the application server 101 may also be envisaged.

Similarly, any consumption data that is entered into the system 100 may also be stored, in an information database or otherwise, configured within the hard disk drive 110 of the application server 101. Alternatively, the information database may be stored on a separate user company's server, hi this case, the data may be uploaded via a secure connection to the application server 101. The system 100 may be arranged for such uploads on a regular basis or only for uploads on demand. Typically managers or dedicated officers located at the various assets in a portfolio will have the responsibility of entering the consumption data. The consumption data entry may be effected by way of local or remote terminals 151A and 151B, communicating with the application server 101 by way of the WAN 120 and LAN 122, respectively.

The consumption data may comprise one or more operational parameters associated with the use of the operational units within an inventory group (i.e. a group of assets). The value of each operational parameter is in some way indicative of the resource consumption of the respective inventory group. For example, the operational parameters may be related to the number of operational units in each asset or inventory group (i.e. group of assets), the recourse consumption of one operational unit or a group of units etc.

With respect to access and user rights, the computer application program 133 is arranged to provide various personnel within a respective business activity, enterprise or organisation with prescribed levels of access to the information database and the computer application program 133. Such prescribed levels of access are both intended to safeguard data and to provide an automatically and fully documented audit trail.

The method starts with the step 102 where the computer application program 133, under the execution of the processor 105, receives consumption data indicative of a resource consumption of the one or more inventory groups under consideration. The received consumption data may be purely related to the consumption of one or more resources within the defined geographical area (plus any other assets under control by the local government authority).

The consumption data may be only indirectly related to the amount of a consumed resource. For example, instead of providing directly the amount of energy consumed by an individual unit, data may be received that includes hours of operation and hourly energy consumption of the unit. This data is still indicative of, and may be used for the determination of the energy consumption of the unit.

It will be understood that the consumption data may also include information regarding vehicles, both publicly and privately owned, that generally operate within, pass through or are under control of the local government area. Moreover, as data on individual vehicles may not be available, it will be understood that the consumption data may be provided in an appropriate aggregate form, in the form of the total traffic throughput across particular roads, the general vehicle mix (e.g. vehicle type, fuel type, etc.) in the geographical area and the total number of public transport journeys undertaken over a defined period of time, to name a few examples.

Alternatively, the data entered into the information database, configured within the hard disk drive 110, may actually include the type of resources and the amount of consumed resource of each type. In this instance, the data received at step 102 of the application program 133, when executed by processor 105, may include the consumption of grid energy (e.g. by all types of appliances), various fuels (e.g. consumed either directly by a particular fleet, or indirectly, by hiring taxis or by purchasing of bus, train and airline tickets), as well as CFC, HFC and HCFC and other gases (e.g. associated with leakages of refrigerators and air conditioners). The number and/or type of appliances, vehicles or other operational units included in each subgroup (or inventory group) may also be included if detailed modelling is to be performed on the basis of the received data.

The process of entering the consumption data is typically effected by authorised management staff at the user's sites via the input terminals 151A and 151B, linked to the dedicated application server 101 by way of WAN 120 or LAN 122, respectively. After undergoing security checks, a user may access the application server 101 for entering consumption data, business data and/or extracting a report of performed scenario modelling in accordance with the method.

Once the consumption of all inventory groups is entered and/or received by the computer application program 133 executed by processor 105, at the next step 104, factual (or real life) GHGe (i.e. sustainability metrics), of the inventory groups are determined.

Through a relational database, the consumption data is saved and related to the respective organisation using id values between tables to establish the relationship. A single database is used data, although it will be understood that various databases may be utilised. However, because each record for each table in the database is attached to a specific organisation, each user can only view, edit or update the records and information respective to their organisation, in accordance with their user profile. In the same way, any new record created through the application will be attached to the respective organisation. A user from an organisation is unable to view, edit or update records for another organisation because of constraints added at the database and web level that forbid this unless the user is a Kinesis user.

Kinesis users have an administrator account that has all privileges to modify in the database the parameters related to any specific organisation when it is necessary.

Although not required, the embodiments described with reference to the Figures can be implemented as an Application Programming Interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by computing system or partly implemented by computing systems then any appropriate computing system architecture may be utilised. This will include stand alone computers, network computers and dedicated hardware devices. Where the terms “computing system” and “computing device” are used, these terms are intended to cover any appropriate arrangement of computer hardware capable of implementing the function described.

Furthermore, it will be understood that where a client server architecture is utilised, the display device may be remote from the computing device which undertakes the substantive modeling. In such situations the display device may be a portable computing device a mobile telephone or any other mobile device capable of receiving data and displaying data in an appropriate format.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. A method of visualising a sustainability metric of one or more inventory groups, each group comprising one of more operational units, the method comprising the steps of:
receiving at least one of consumption data and one or more inventory parameters associated with each of the one or more inventory groups;
determining a factual sustainability metric of the one or more inventory groups, based on the received at least one of consumption data and one or more inventory parameters;
determining a model sustainability metric of the one or more inventory groups in at least one model scenario, the model scenario comprising modifying at least one of received consumption data and a received inventory parameter, to assess the effect of the modification of the factual sustainability metric; and
displaying at least one of the sustainability metric groups and the inventory or the consumption data in a Graphical User Interface.

2. The method of claim 1, further comprising a Graphical User Interface having at least two sub-regions, the first sub-region providing a visual representation of the one or more inventory groups, and the second sub-region containing one or more of the consumption data and the sustainability metric.

3. The method of claim 1, wherein the inventory groups are collocated within a geographical area.

4. The method of claim 3, wherein the geographical area is displayed as a map.

5. The method of claim 4, wherein the map is interactive, to allow a user to view sub-regions of the map in more detail.

6. The method of claim 5, wherein the information in the second sub-region is varied to reflect the sub-region selected by the user.

7. The method of claim 1, wherein the display provides a series of graphs, the graphs providing an aggregate of at least one of the consumption data, the one or more inventory parameters associated with the one or more inventory groups and the at least one model scenario.

8. A system for visualising a sustainability metric of one or more inventory groups, each group comprising one of more operational units, the method comprising the steps of:
a receiving module to receive at least one of consumption data and one or more inventory parameters associated with each of the one or more inventory groups; a determining module arranged to determine a factual sustainability metric of the one or more inventory groups, based on the received at least one of consumption data and one or more inventory parameters;
the determining module also being arranged to determine a model sustainability metric of the one or more inventory groups in at least one model scenario, the model scenario comprising modifying at least one of received consumption data and a received inventory parameter, to assess the effect of the modification of the factual sustainability metric; and
and a display module arranged to provide instructions to display at least one of the sustainability metric groups and the inventory or the consumption data in a Geographical User Interface.

9. The system of claim 8, further comprising a Graphical User Interface having at least two sub-regions, the first sub-region providing a visual representation of the one or more inventory groups, and the second sub-region containing one or more of the consumption data and the sustainability metric.

10. The system of claim 8, wherein the inventory groups are collocated within a geographical area.

11. The system of claim 10, wherein the geographical area is displayed as a map.

12. The system of claim 11, wherein the map is interactive, to allow a user to view sub-regions of the map in more detail.

13. The system of claim 12, wherein the information in the second sub-region is varied to reflect the sub-region selected by the user.

14. The system of claim 8, wherein the display provides a series of graphs, the graphs providing an aggregate of at least one of the consumption data, the one or more inventory parameters associated with the one or more inventory groups and the at least one model scenario.

15. A computing program, arranged to, when executed on a computing system, perform the method steps of claim 1.

16. A computer readable medium incorporating a computer program in accordance with claim 15.
